(19) United States
(12) Patent Application Publication
(10) Pub. No.: US 2010/0251086 A1
(43) Pub. Date: Sep. 30, 2010

(54) METHOD AND APPARATUS FOR PROVIDING HYPERLINKING IN TEXT EDITING

(76) Inventors: Serge Rene HAUMONT, Helsinki (FI); Juha Heikki Salo, Littoinen (FI); Kimmo Kalevi Viheriala, Helsinki (FI); Mikko Antero Nurmi, Tampere (FI)

Correspondence Address: DITTHAVONG MORI & STEINER, P.C., 918 Prince Street, Alexandria, VA, 22314, US

(21) Appl. No.: 12/412,772

(22) Filed: Mar. 27, 2009

(51) Int. Cl. G06F 17/00

(52) U.S. Cl. 715/205; 715/255

(57) ABSTRACT

An approach is provided for associating one or more content identifiers with respective keywords. While a user is using a text editing application, the input is monitored to determine when one of the respective keywords is entered. In response, the one or more associated content identifiers are suggested as hyperlinks for that keyword within the message. If the user accepts one of the suggested content identifiers, then an appropriate hyperlink is created.

### BACKGROUND

The exchange of text messages has been a popular means of communicating over the worldwide Internet. More recently, documents that include hypertext have simplified the way people use the Internet by providing a worldwide web of information. Typically, adding hyperlinks to text messages requires some type of manual coding such as composing the message with HyperText Mark-up Language (HTML) elements in such a way that the user explicitly links a term in the message with an address to some other separate content. Some text editors allow users to select terms in a message and then through drop-down boxes or other interface elements permit the user to manually enter an address for a hyperlink, such efforts still require the user to know of the outside content resource and know the proper correct form of an address to reach that content. Thus, adding hyperlinks to text messages is difficult, complex and time-consuming for users.

### Some Exemplary Embodiments

Therefore, there is a need for an approach for automatically providing suggestions for hyperlinks to relevant content related to text being entered at text editing software.

According to one embodiment, a method includes detecting that a predetermined sequence of characters is received by a text editor, determining one or more content identifiers related to the predetermined sequence of characters; and then initiating the sending of a request to the text editor to associate with the predetermined sequence of characters a hyperlink selected from the one or more content identifiers.

According to another embodiment, an apparatus includes a processor and a memory storing executable instructions that if executed cause the apparatus to at least perform the following steps: detecting that a predetermined sequence of characters is received by a text editor; determining one or more content identifiers related to the predetermined sequence of characters; and initiating sending of a request to the text editor to associate with the predetermined sequence of characters a hyperlink selected from the one or more content identifiers.

According to yet another embodiment, a computer-readable storage medium carrying one or more sequences of one or more instructions which, when executed by one or more processors, cause the one or more processors to perform a number of steps. For example, such as, at least performing the steps of: detecting an acceptance of the request for a selected one of the one or more content identifiers; generating the hyperlink corresponding to the selected content identifier; and initiating sending the hyperlink to the text editor.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is diagram of a communications system capable of providing hyperlinking, according to one embodiment;

FIG. 2 is a diagram of a communication system involving a service provider implementing a hyperlink suggestion mechanism, according to an exemplary embodiment;

FIG. 3A is a flowchart of a process for suggesting hyperlinks by a text editor, according to one embodiment;

FIG. 3B is a flowchart of a process for determining suggested hyperlinks, according to one embodiment;

FIG. 4 is a flowchart of a process for text editing including suggested hyperlinks, according to one embodiment;

FIG. 5 is a flowchart of a process for associating keywords and hyperlinks, according to one embodiment;

FIGS. 6A-6C are flowcharts of a processes for exemplary use cases for applying a hyperlinking function, according to various embodiments;

FIG. 7A is a diagram of components of a user device, according to one embodiment;

FIG. 7B is a system diagram of functional components configured to provide hyperlinking, according to one embodiment;

FIG. 7C is a diagram of a system capable providing advertising information, according to one embodiment;

FIG. 7D is a flowchart of a process for providing advertising information, according to one embodiment.

FIG. 8 is a diagram of hardware that can be used to implement an embodiment of the invention;

FIG. 9 is a diagram of a chip set that can be used to implement an embodiment of the invention; and

FIG. 10 is a diagram of a mobile station (e.g., handset) that can be used to implement an embodiment of the invention.

### DESCRIPTION OF PREFERRED EMBODIMENT

A method and apparatus for suggesting hyperlinks by a text editor are disclosed, wherein a “text editor”, as used herein, includes editors having a user interface that allows a user to author content that may include visual content, textual content, multimedia content, and other types of content as well. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

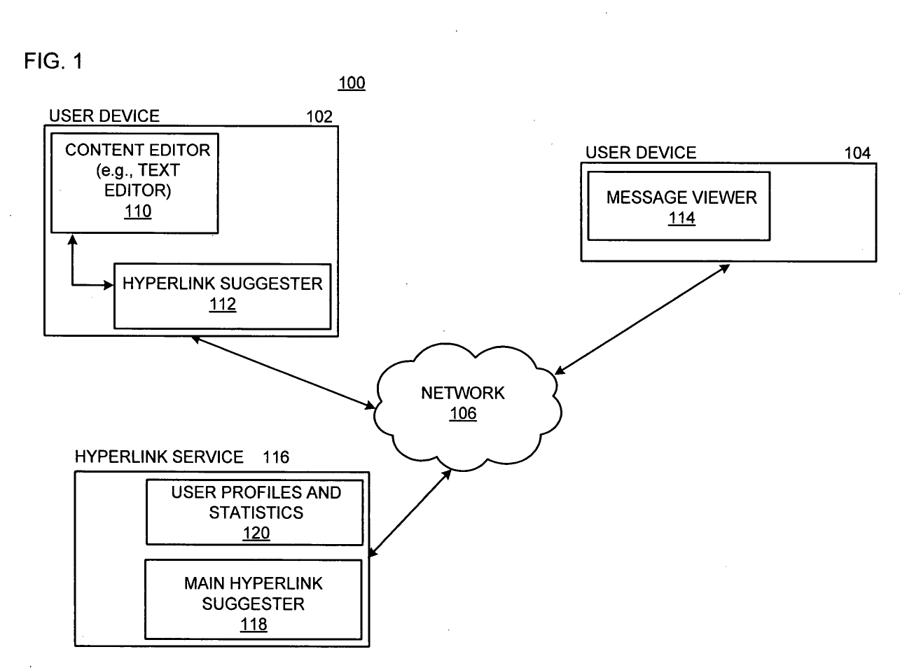

FIG. 1 is diagram of a communications system capable of providing hyperlinking, according to one embodiment. Within the system 100, a user of device 102 can communicate with another user's device 104 in a variety of different ways over the network 106. For example, a content editor, or text editing application, 110 on the user device 102 can be used to create a message such as a text message. The devices 102 and 104 can be any type of fixed terminal, mobile terminal, or portable terminal including desktop computers, laptop computers, handsets, stations, units, devices, multimedia tablets, Internet nodes, communicators, Personal Digital Assistants (PDAs), or any combination thereof. It is also contemplated that the devices 102 and 104 can support any type of interface to the user (such as “wearable” circuitry, etc.).

In accordance with at least some embodiments, a hyperlink suggester 112 resides on the user device 102 to augment the operation of the text editor 110. While the user is using the text editor 110, the hyperlink suggester 112 may offer different hyperlink suggestions relevant to the text of the message being typed and then add those hyperlinks to the message if the user desires. A hyperlink creates a connection between the text (e.g., word, phrase, symbol, image, etc.) to another text, document, file or script. Hyperlinks can be identified through tags in markup languages, such as HyperText Markup Language (HTML) or Standard Generalized Markup Language (SGML). Once a message is composed, it is sent over the network 106 to the user device 104 where it can be viewed using an appropriate message viewer 114. The message viewer 114 may advantageously include the capability to follow any embedded hyperlinks in the message to discover content in addition to that of the original message.

The hyperlink suggesting function may be distributed across multiple platforms such as a hyperlink service 116 that includes a main hyperlink suggester 118 that works in conjunction with the hyperlink suggester 112 that is local to the user device 102. In at least one embodiment, the main hyperlink suggester 118 delivers hyperlink suggestions to the local hyperlink suggester 112. This delivering of hyperlink suggestions may be, for example, in response to a request sent by the local hyperlink suggester 112. Thus, the local hyperlink suggester 112 interacts with the text editor 110 of the user device 102 but the main hyperlink suggester 118 provides at least some of the hyperlinks to the local hyperlink suggester 112 so that they can be suggested to the user.

The hyperlink service 116 may also maintain user profiles and statistics 120 about hyperlink suggestions, user preferences, past hyperlink acceptances, and other information. For example, the communication between the local hyperlink suggester 112 and the hyperlink service 116 may include information about the user of the device 102. Based on past statistics, the hyperlink service 116 may identify popular, or preferred, hyperlinks for this particular user or for similar users. The hyperlink service may also store in the user profiles 120 information that relates to the type of hyperlinks the user prefers (e.g., no advertisements) or how frequently the user desires to receive a hyperlink suggestion. These user profiles and statistics 120 can be accessed by the hyperlink service 116 to control how and when it suggests various hyperlinks to the local hyperlink suggester 112. The statistics 120 may be received from the local hyperlink suggester 112 and stored by the hyperlink service 116 as each hyperlink is suggested or may be transmitted as a batch of information that was collected over a period of time at the user device 102. The hyperlink service may also include a dynamically changing list of popular hyperlinks that are based on current news items, current sporting events, or the like so that the suggested hyperlinks may be relevant to recent events.

By way of example, the communication network 106 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, mobile ad-hoc network (MANET), and the like.

By way of example, the devices 102 and 104 communicate with other devices (i.e., network nodes) on the communication network 106 using standard protocols. In this context, a protocol includes a set of rules defining how the network nodes within the communication network 106 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model. The OSI Reference Model is generally described in more detail in Section 1.1 of the reference book entitled “Interconnections Second Edition,” by Radia Perlman, published September 1999.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

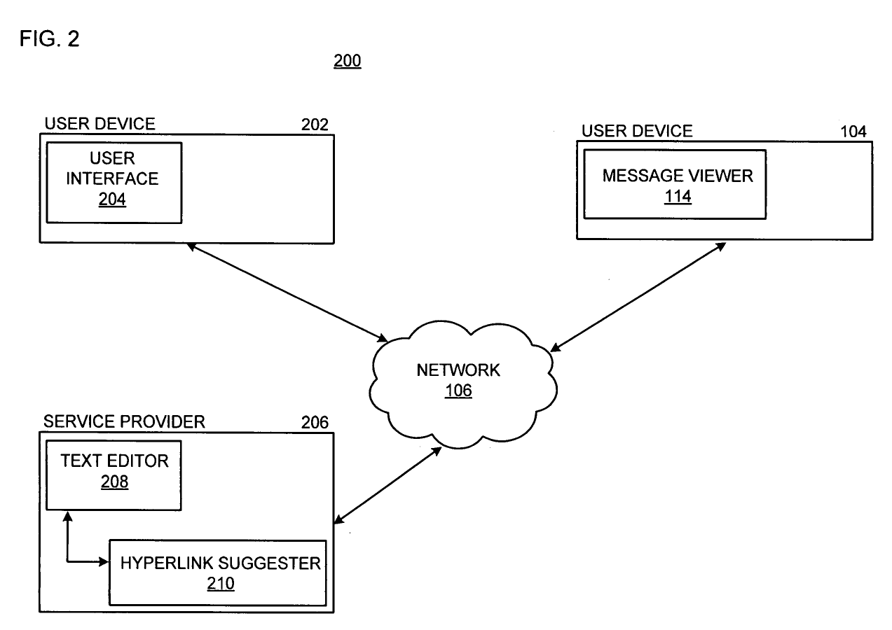

FIG. 2 is a diagram of a communication system involving a service provider implementing a hyperlink suggestion mechanism, according to an exemplary embodiment. As shown in FIG. 2, a user may operate, within communication system 200, a user device 202 to indirectly compose and send a message to the other user device 104. The user interface 204 of the user device 202 allows a user to enter numbers, letters, and other characters by a variety of different methods. For example, the user interface 204 may include hardware components such as a keypad corresponding to different characters, or the user interface 204 may be more of a virtual interface where characters are selected from a graphical display on a screen. Because the user device 202 may in some instances be a small handheld device and in other instance be a more traditional computer, the user interface 204 may vary greatly depending on the capabilities of the device 202 itself.

Using the interface 204, the user may connect with a service provider 206 over the network 106. The service provider 206 may provide a number of different services with one particular service being a text editor 208. Examples of such service providers 206 include blogging sites as well as online text editors. The user utilizes the text editor 208 to compose a message that can be read by the user device 104 using an appropriate message viewer 114. According to at least some embodiments, the text editor 208 is augmented with a hyperlink suggester 210 that offers different hyperlink suggestions relevant to the text of the message being typed. Once a message is composed, possibly with embedded hyperlinks, it is sent over the network 106 to the user device 104 where it can be viewed using an appropriate message viewer 114. The message viewer 114 may advantageously include the capability to follow any embedded hyperlinks in the message to discover content in addition to that of the original message.

In an exemplary scenario, as a user is entering the characters of a message, the hyperlink suggester (e.g., 112, 210) may detect that a predetermined keyword or a predetermined sequence of characters has been entered. For each such keyword, or character sequence, the hyperlink suggester may have one or more content identifiers associated therewith. A content identifier may, for example, include web sites, web pages, Uniform Resource Identifiers (URIs), and similar identifiers to where additional content may be located. For example, for the keyword “automobile” a content identifier may identify the home page for a particular car manufacturer or possibly an advertisement for an automobile-related magazine or product. If the keyword is a medical term, then the content identifier may identify a wikipedia page related to that keyword, or may identify a product for treatment related to that keyword, or identify a government web site. In each instance, the hyperlink suggester (e.g., 112, 210) suggests through the text editor that a relevant content identifier may be added as a hyperlink associated with a keyword being entered or a series of words being entered.

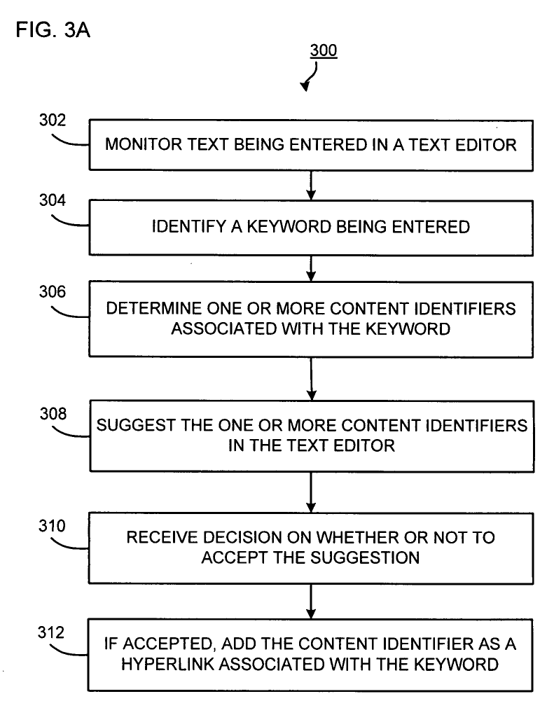

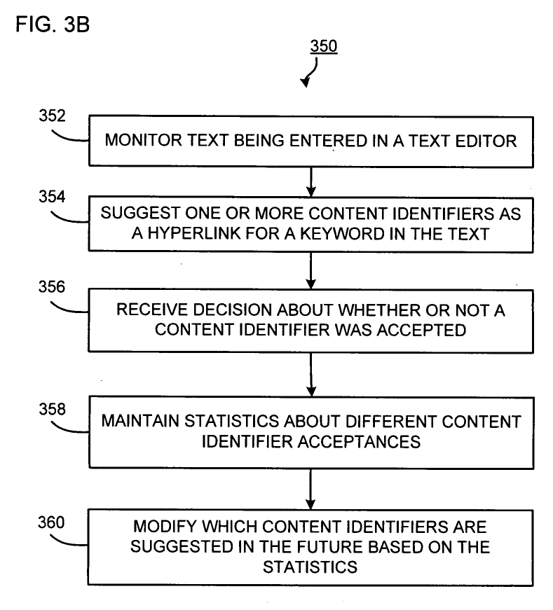

FIG. 3A is a flowchart of a process for suggesting hyperlinks by a text editor, according to one embodiment. In process 300, the text being entered in a text editor is monitored in step 302. The text editor may monitor the text and then generate a signal that a keyword has been entered or a functional module separate from the text editor may perform this monitoring. Based on the monitoring, however, a keyword or a predetermined sequence of characters is identified in step 304. Once this keyword is identified then the one or more content identifiers associated with that keyword are determined in step 306. Each keyword may, for example, have a single content identifier associated with it or may have a plurality of associated content identifiers. Having more than one associated content identifier allows a user to be presented with more options when selecting an appropriate hyperlink to insert in a message; however, too many suggested content identifiers may distract a user composing a message. As mentioned with respect to FIG. 1, the identifying of one or more content identifiers associated with a keyword can be performed by a component local to a user device and a network component that can collect and store user profiles and statistics about the hyperlinks that are suggested and accepted. The network component can then use the stored profiles and statistics to refine the content identifiers that are identified for presentation to a user.

Thus, in step 308, the associated one or more content identifiers are presented, or suggested, to the user composing a message. In at least some embodiments, a window or message will appear on the screen of the text editor with a list of the content identifiers in such a way that the user may reject all the suggestions or accept one of the suggestions for a hyperlink. In step 310, the decision of the user is received and, if appropriate, a hyperlink is added, in step 312, for that keyword within the text of the message. It is possible that some users may not like their message writing continually being interrupted by hyperlink suggestions and so in at least some embodiments, the frequency of suggested hyperlinks is limited. For example, a setting may be available that limits only one suggestion for every 100 characters entered, or one suggestion for every 50 words entered; of course these specific numbers may vary. This setting may also be user selectable so that a user can set the frequency to any number that they desire.

Another way to control some aspects of which content identifiers are suggested to users is to monitor which content identifiers are frequently accepted for certain keywords and which are routinely not accepted or selected. FIG. 3B is a flowchart of a process for determining suggested hyperlinks, according to one embodiment. According to process 350, the text being entered in a text editor is monitored in step 352 so that, in step 354, a suggestion for one or more relevant content identifiers can be made when a keyword is entered. When a decision by the user regarding whether or not to accept a content identifier is made, in step 356, statistics are maintained for the different content identifiers, in step 358. One of ordinary skill will recognize that a variety of different statistics can be generated for the different keywords and the different content identifiers. The statistics may simply include rejection/acceptance rates (e.g., “accepted 85% of the time”) or may include demographic information if a user profile is available (e.g., “accepted 45% by males under 35 years old”). Other information such as the time of day, information about the message recipient, other keywords in the message, the season of the year, etc. may be included in the statistics to further analyze the acceptance and rejection characteristics of particular content identifiers associated with various keywords. These statistics may be tied to an individual user or may be for a collection of users using a particular text editor.

Based on the statistics, the content identifiers that are suggested in the future for a keyword may be modified, in step 360. For example, a content identifier that has an acceptance rate below a certain threshold may be disassociated from a keyword and no longer offered as a suggestion. Also, a content identifier may be associated with a keyword in such a way that it is suggested to only certain users matching a particular profile or suggested only if other keywords are present in the message.

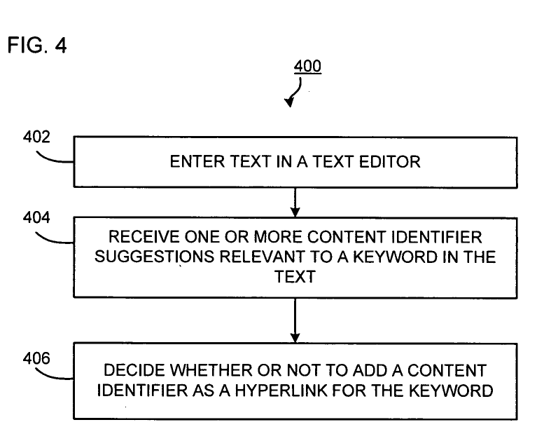

FIG. 4 is a flowchart of a process for text editing including suggested hyperlinks, according to one embodiment. By considering the possibility that some users may not want to be continually interrupted with suggestions, as mentioned before, the user experience of using a text editor will remain familiar while gaining the additional ability of easily adding relevant content to a message through hyperlinks. In process 400, the user enters text into a text editor, as in step 402, whether it be through a mobile device, for example, when instant messaging or text messaging, or through a user interface that connects with a third party service provider such as a blog site or an online text editor. While composing the message, the user is presented, in step 404, with one or more suggested content identifiers that identify content related to a word that was just entered. The suggested content identifiers may, for example, be related to advertisements relevant to that word or to other information sources relevant to that word. In step 406, the user accepts one of the content identifiers (or not) and the text editor then makes that word a hyperlink linking to the accepted content identifier. Thus, the readability of the message is not diminished but the recipient of the message will be able to easily access additional relevant information using the embedded hyperlinks if desired.

The ability to associate content identifiers with keywords may be controlled by a developer of a text editor or by a manufacturer of a device on which a text editor may run. In the case of online service providers, that provider may also control which content identifiers are associated with certain keywords. One result of this is that the association of keywords and content identifiers may be used to produce a revenue stream with content providers bidding on having their identifiers to their content be the ones associated with keyword. Advertisers and manufacturers will likely desire to have their content identifiers suggested, especially on popular platforms, popular text editing applications, and popular web sites and be willing to pay for this ability. The entity that controls which content identifiers are associated with each keyword may also take into account the popularity of the content identifiers being accepted when they are suggested. Thus, even if a company may bid highly to have their content identifier associated with a keyword, that bid may fail if the content identifier fails to generate any interest when suggested to users or may link to inappropriate content depending on the forum being presented.

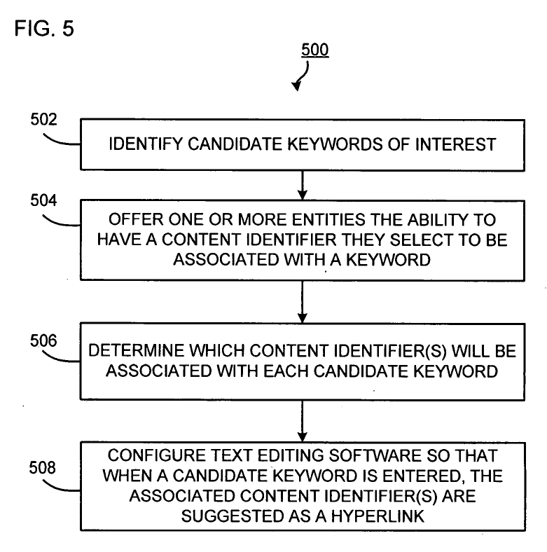

FIG. 5 is a flowchart of a process for associating keywords and hyperlinks, according to one embodiment. By way of example, process 500 involves a blogging application. Namely, an entity such as, for example, a blogging site may identify, in step 502, a number of candidate keywords. These keywords may then be offered, in step 504, to a variety of third parties to determine if those third parties would like to have their content identifiers associated with one or more of the keywords. In step 506, the blogging site then determines which content identifiers will be associated with each keyword. As mentioned, such a determination can be based on a combination of factors such as expected revenue, popularity, forum appropriateness, etc. In step 508, the text editing software or modules connecting to the text editing software are configured to suggest the appropriate content identifiers when a keyword is entered.

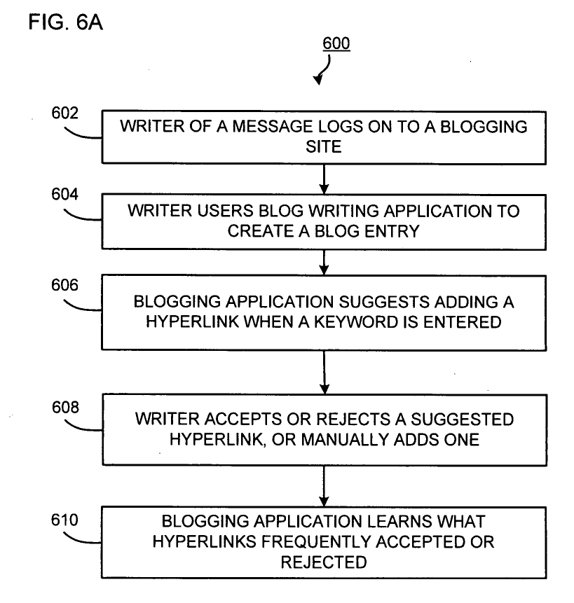

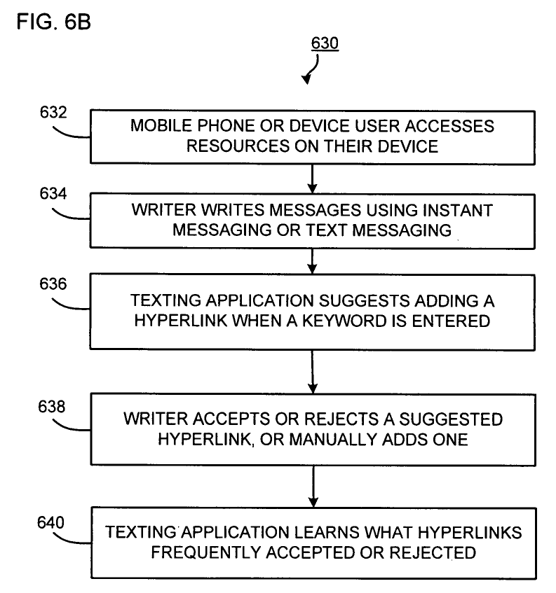

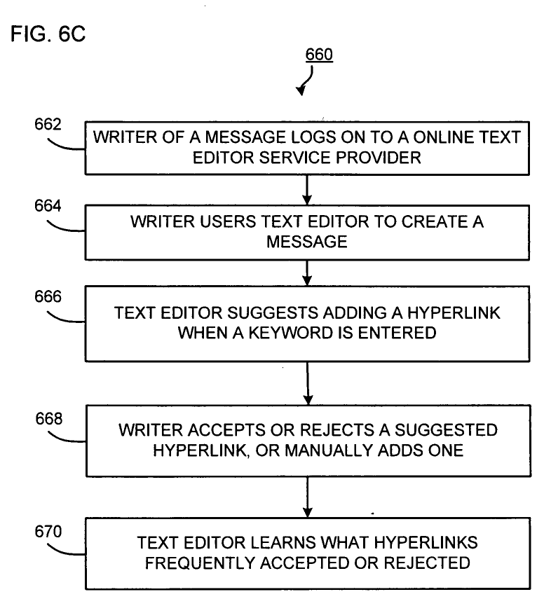

FIGS. 6A-6C are flowcharts (processes 600, 630, 660, respectively) of processes for different use cases, according to various embodiments. In step 602 of FIG. 6A, a writer of a message logs into a blogging site. Using the blog writing application provided at the site, the message writer can begin writing or editing a blog entry, in step 604. As the writer continues to use the blog writing application, the input is monitored so that entry of a keyword will be detected. When a keyword is entered, the blog writing application displays, in step 606, a list of one or more content identifiers that relate to the keyword. In response, in step 608, the blog writer can reject all the suggested identifiers, select one of the identifiers, or manually enter a different identifier. In some embodiments, the blog writing application (or other text editor) can learn the manually entered hyperlink and add it to the list of content identifiers associated with the keyword. Also, in at least some embodiments, the bogging application may learn, in step 610, which content identifiers are popular or unpopular so that future suggestions may be more focused. One potential benefit from a blogging site as just described is that the content identifiers may be linked to advertisements or advertiser's contents for a fee so as to offset the costs of operating the blogging site.

In step 632 of FIG. 6B, a user of a mobile device (e.g., PDA, cellular telephone, smartphone) access the resources of that device for composing a text message. Using these resources such as, for example, a text messaging application or an instant messaging application, the message writer can begin writing or editing a message, in step 634. As the writer continues to use the messaging application, the input is monitored so that entry of a keyword will be detected. When a keyword is entered, the messaging application displays, in step 636, a list of one or more content identifiers that relate to the keyword. In response, in step 638, the message writer can reject all the suggested identifiers, select one of the identifiers, or manually enter a different identifier. In some embodiments, the messaging application (or other text editor) can learn the manually entered hyperlink and add it to the list of content identifiers associated with the keyword. Also, in at least some embodiments, the messaging application may learn, in step 640, which content identifiers are popular or unpopular so that future suggestions may be more focused. One potential benefit from a mobile device as just described is that the content identifiers may be linked to advertisements or advertiser's contents for a fee so as to offset the costs of providing telecommunication service or to reward a user with points or money for linking to the advertisers when sending messages.

In step 662 of FIG. 6C, a writer of a message accesses an online text editor for composing a text message. Using these resources of the online text editor the message writer can begin writing or editing a message, in step 664. As the writer continues to use the online text editor, the input is monitored so that entry of a keyword will be detected. When a keyword is entered, the online text editor displays, in step 666, a list of one or more content identifiers that relate to the keyword. In response, in step 668, the message writer can reject all the suggested identifiers, select one of the identifiers, or manually enter a different identifier. In some embodiments, the online text editor can learn the manually entered hyperlink and add it to the list of content identifiers associated with the keyword. Also, in at least some embodiments, the online text editor may learn, in step 670, which content identifiers are popular or unpopular so that future suggestions may be more focused. One potential benefit from an online text editor provider as just described is that the content identifiers may be linked to advertisements or advertiser's contents for a fee so as to offset the costs of providing the online site and service.

The processes described herein for suggesting hyperlinks by a text editor may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

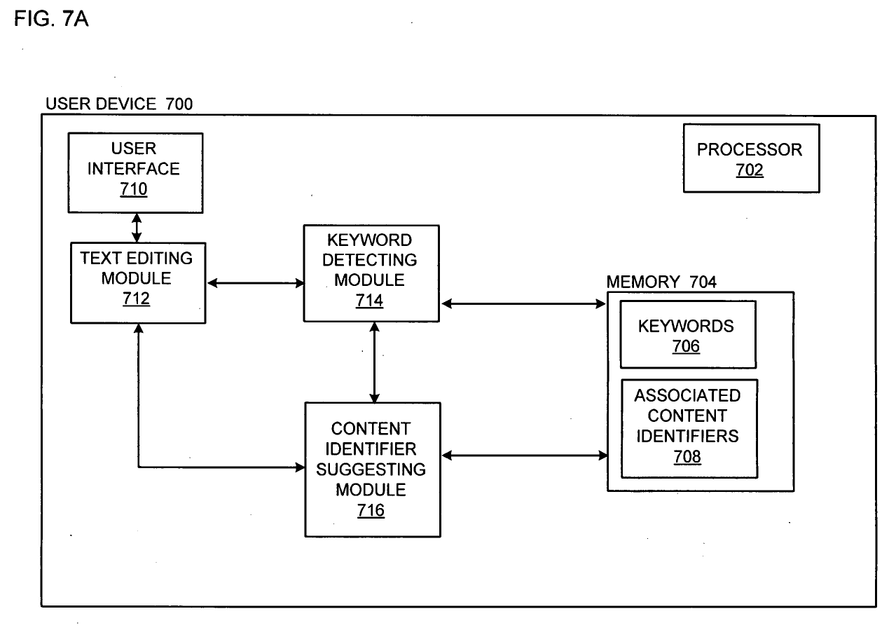

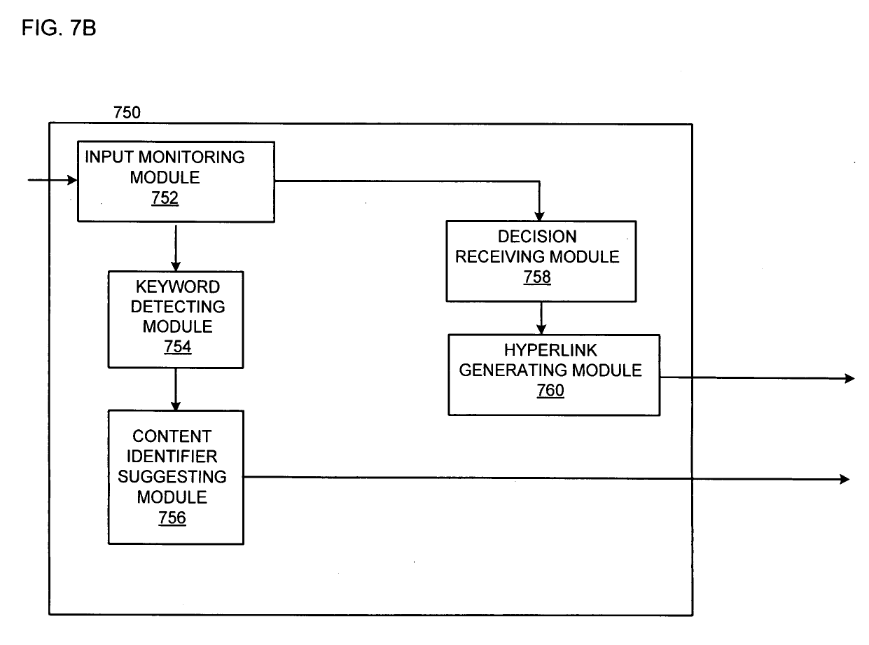

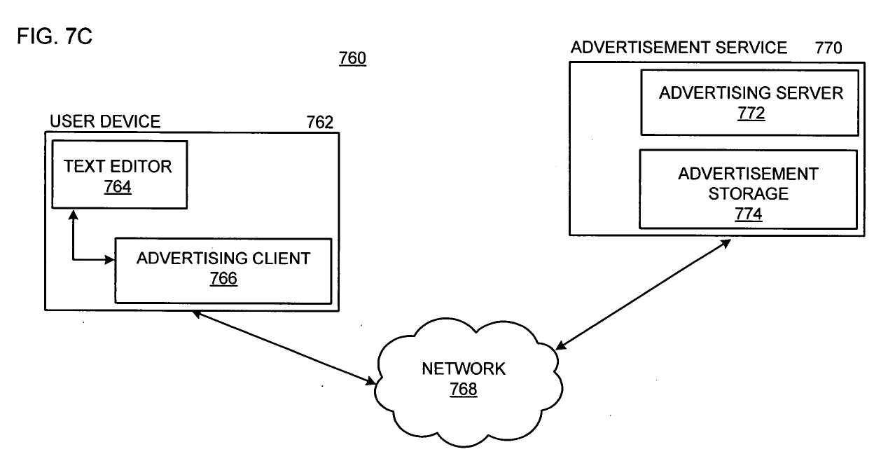

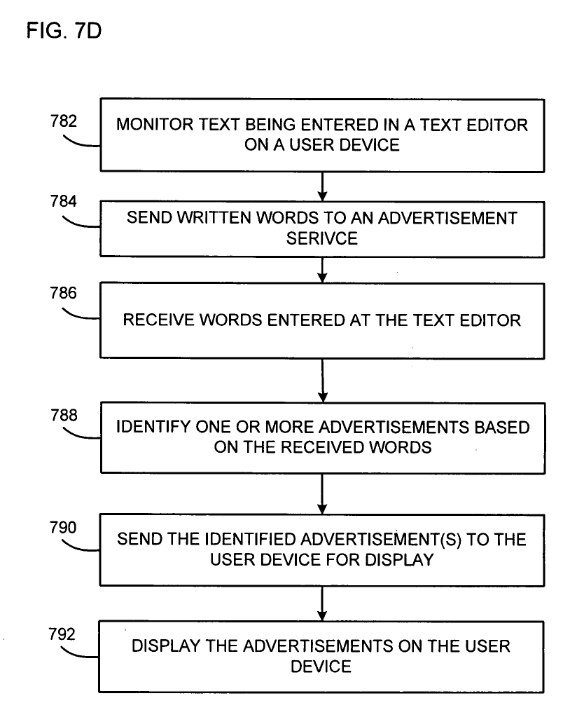

FIG. 7A is a diagram 700 of components of a user device that can be used to implement an embodiment of the invention. The user device 700 may include a processor 702 and memory 704 for a variety of different purposes and for executing many different applications. In addition to executable instructions, the memory 704 may also store other data such as keywords 706 and associated content identifiers 708. In operation, a user of the device 700 interacts with a user to interface 710 to access different resources such as a text editing module 712. In at least some embodiments, the text editing module 712 communicates with a keyword detecting module 714. In accordance with one embodiment, the text editing module 712 sends an indication of what keyword was entered to the keyword detecting module 714; however, in other embodiments, the keyword detecting module 714 monitors the input of the text editing module 712 and based on the keywords 706 in memory detects when a keyword, or predetermined character sequence, is entered by a user.

The keyword detecting module 714 communicates the detected keyword to a content identifier suggesting module 716 which retrieves associated content identifiers 708 from the memory 704. These retrieved associated content identifiers are then presented to the text editing module 712 so that they can be suggested as potential hyperlinks to the user. The text editing module 712 can then add a hyperlink or not depending on the user's instructions.

FIG. 7B is a system diagram 750 of functional components that can be used to implement an embodiment of the invention and focuses on components that interact with a text editor. An input monitoring module 752 monitors text or characters that are input to a text editor. In one instance, the input monitoring module 752 communicates with a keyword detecting module 754 so that the detecting module 754 can determine when the characters being input match a predetermined keyword. The detected keyword is then communicated to a content identifier suggesting module 756. Each predetermined keyword has an associated set of one or more content identifiers that identify content relevant for that keyword. The suggesting module 756 determines the content identifiers associated with the keyword and communicates them to the text editor where the message is being composed. In a second instance, the input monitoring module 752 receives an indication from the text editor when a content identifier has been accepted by a user. This indication is communicated to a decision receiving module 758 that determines which of the content identifiers, if any, were accepted or rejected by the user. Based on the decision, a hyperlink generating module 760 generates a hyperlink corresponding to the selected content identifier which the text editor can then insert in the message being composed.

FIG. 7C is a diagram of a system 760 that provides advertising information to a user device 762. In one embodiment, the user device 762 includes an application such as a text editor 764 or other content editor in which a user can compose a message. It is contemplated that a message, according to certain embodiments, may involve any type of written material. For example, the text editor 764 may be part of an email application or a text messaging application. An advertising client 766 is also present that interacts with the text editor. 764. In operation, the advertising client 766 can be automatically started when the text editor 764 is opened to compose a message. The advertising client 766 monitors the text being entered in the text editor 764 and then transmits at least some of these words across the network 768 to an advertisement service 770.

The advertising service 770 includes a server application 772 that receives the text from the advertising client 766 and identifies key words or themes in that text that help identify relevant advertisements stored in the storage 774. Once one or more relevant advertisements are identified and retrieved from the storage 774, they can be sent by the advertising server 772 to the advertising client 766. The advertisements can then be displayed on the user device 762. The advertisements may, for example, be text, images, audio, video, multimedia or hyperlinks to additional content or a combination of these. The sequence of monitoring the entered words and sending related advertisements for display occurs dynamically while the message is being composed so that the advertisements displayed to the user can repeatedly change.

The advertising client 766 can filter some words as less relevant than others in order to reduce the number of words sent by the advertising client 766 to the advertisement service 770. The advertising client 766 can also control the length of time an advertisement is displayed on the user device. For example, the advertising server 772 may have transmitted five advertisements to the advertising client 866 as relevant but the advertising client may allow only three to be shown and wait a predetermined time period before showing the remaining two. In this manner, each advertisement will be available for at least a preset minimum time and the user will not be distract by advertisements that change too fast. The function of filtering irrelevant words and determining the timing of the advertisements may alternatively be performed by the advertising server 772 as well.

FIG. 7D is a flowchart of a process for providing advertising information, according to one embodiment. In step 782, the text or content being entered into a text editor, or content editor, of a user's device is monitored. The words that are being entered on the user device are sent to an advertisement service that provides advertisements relevant to the words, in step 784, to be received, in step 786, by the advertisement service. At the advertisement service, the words being entered are analyzed to determine keywords or themes that might be used to identify, in step 788, advertisements relevant to the message being composed. These advertisements are identified from among a variety of different advertisements stored at the advertisement service where they can be retrieved for transmission. In step 790, the advertisement service sends the relevant advertisements to the user where the user device then, in step 792, displays the relevant advertisements. The display of relevant advertisements may be accomplished in a separate display window or as part of the text editor user interface display. This process repeats itself as the user continues to enter more text so that the advertisements dynamically change as the message is composed.

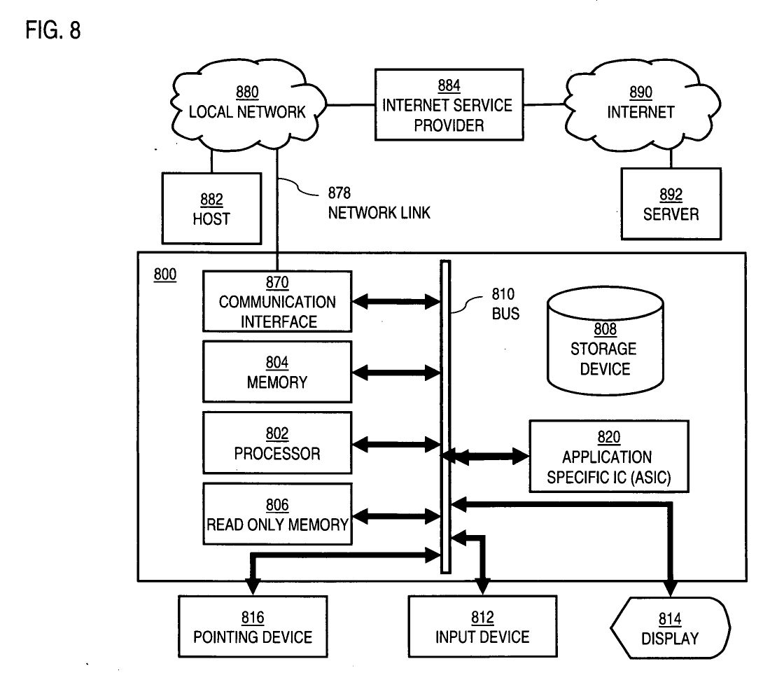

FIG. 8 illustrates a computer system 800 upon which an embodiment of the invention may be implemented. Computer system 800 is programmed to carry out the inventive functions described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information. The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

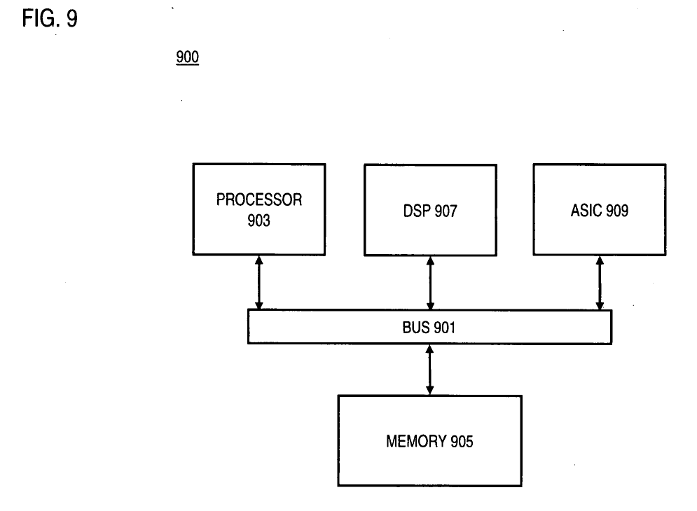

FIG. 9 illustrates a chip set 900 upon which an embodiment of the invention may be implemented. Chip set 900 is programmed to carry out the inventive functions described herein and includes, for instance, the processor and memory components described with respect to FIG. 8 incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-word signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein. The memory 905 also stores the data associated with or generated by the execution of the inventive steps.

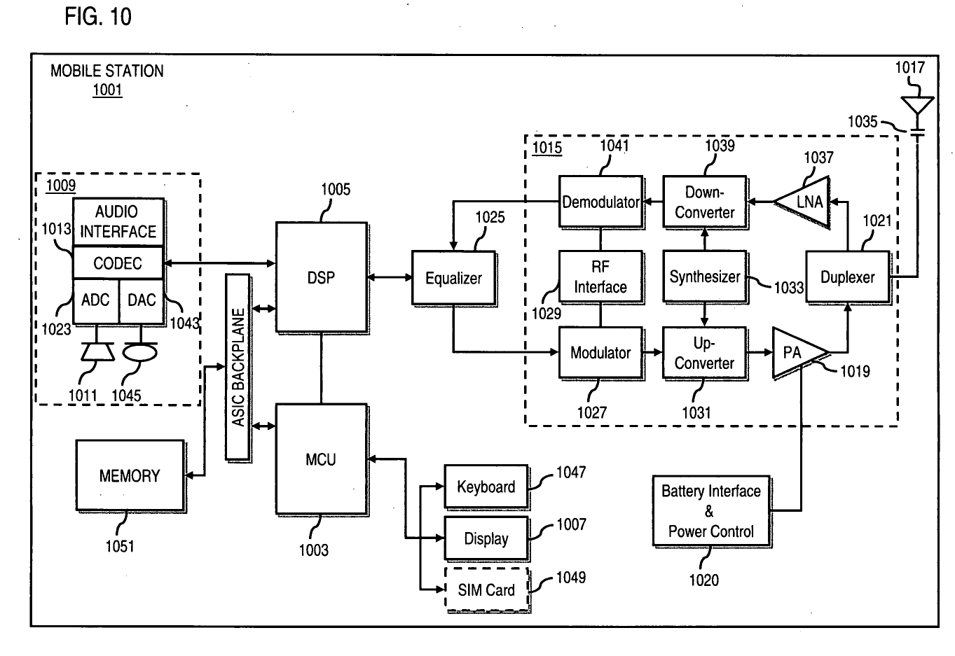

FIG. 10 is a diagram of exemplary components of a mobile station (e.g., handset) capable of operating in the system of FIG. 1, according to an exemplary embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In the exemplary embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003-which can be implemented as a Central Processing Unit (CPU) (not shown).

The MCU 1003 receives various signals including input signals from the keyboard 1047. The MCU 1003 delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
detecting that a predetermined sequence of characters is received by a content editor;
determining one or more content identifiers related to the predetermined sequence of characters; and
initiating sending of a suggestion to the content editor to associate with the predetermined sequence of characters a hyperlink selected from the one or more content identifiers.

2. A method of claim 1, further comprising:
detecting an acceptance of the suggestion for a selected one of the one or more content identifiers;
generating the hyperlink corresponding to the selected content identifier; and
initiating sending the hyperlink to the content editor.

3. A method of claim 2, further comprising:
receiving character input for the content editor to compose a word or a sequence of words; and
adding the hyperlink to the word or the sequence of words.

4. A method of claim 1, wherein the one or more content identifiers comprise respective one or more uniform resource identifiers.

5. A method of claim 1, wherein at least one of the one or more content identifiers refer to an advertisement related to the predetermined sequence of characters.

6. A method of claim 1, further comprising:
storing settings related to user preferences about hyperlinks; and
modifying the determining of the one or more content identifiers based on the settings.

7. A method of claim 1, further comprising:
detecting a user generated content identifier; and
generating the hyperlink corresponding to the user generated content identifier.

8. A method of claim 1, further comprising:
maintaining statistics about which of the one or more content identifiers is selected; and
based on the statistics, modifying the one or more content identifiers related to the predetermined sequence of characters.

9. An apparatus comprising a processor and a memory storing executable instructions that if executed cause the apparatus to at least perform the following:
detecting that a predetermined sequence of characters is received by a content editor;
determining one or more content identifiers related to the predetermined sequence of characters; and
initiating sending of a suggestion to the content editor to associate with the predetermined sequence of characters a hyperlink selected from the one or more content identifiers.

10. An apparatus of claim 9, wherein the apparatus is included in a handset configured to send text messages over a communication network that includes a wireless network.

11. An apparatus of claim 9, further comprising executable instructions that if executed cause the apparatus to at least perform the following:
detecting an acceptance of the suggestion for a selected one of the one or more content identifiers;
generating the hyperlink corresponding to the selected content identifier; and
initiating sending the hyperlink to the content editor.

12. An apparatus of claim 9, wherein the predetermined sequence of characters correspond to one of a plurality of predetermined keywords.

13. An apparatus of claim 12, further comprising executable instructions that if executed cause the apparatus to at least perform the following:
storing a respective set of content identifiers associated with each of the predetermined keywords.

14. An apparatus of claim 9, further comprising executable instructions that if executed cause the apparatus to at least perform the following:
maintaining statistics about which of the one or more content identifiers is selected; and
based on the statistics, modifying the one or more content identifiers related to the predetermined sequence of characters.

15. A computer-readable storage medium carrying one or more sequences of one or more instructions which, when executed by one or more processors, cause the one or more processors to at least perform the following steps:
detecting that a predetermined sequence of characters is received by a content editor;
determining one or more content identifiers related to the predetermined sequence of characters; and
initiating sending of a suggestion to the content editor to associate with the predetermined sequence of characters a hyperlink selected from the one or more content identifiers.

16. A computer-readable storage medium of claim 15, wherein at least one of the one or more content identifiers refer to an advertisement related to the predetermined sequence of characters.

17. A computer-readable storage medium of claim 15, further comprising one or more instructions which, when executed by one or more processors, cause the one or more processors to at least perform the following steps:
detecting an acceptance of the suggestion for a selected one of the one or more content identifiers;
generating the hyperlink corresponding to the selected content identifier; and
initiating sending the hyperlink to the content editor.

18. A computer-readable storage medium of claim 15, further comprising one or more instructions which, when executed by one or more processors, cause the one or more processors to at least perform the following steps:
storing settings related to user preferences about hyperlinks; and
modifying the determining of the one or more content identifiers based on the settings

19. A computer-readable storage medium of claim 15, further comprising one or more instructions which, when executed by one or more processors, cause the one or more processors to at least perform the following steps:
storing settings related to user preferences about hyperlinks; and
modifying the determining of the one or more content identifiers based on the settings.

20. A computer-readable storage medium of claim 15, further comprising one or more instructions which, when executed by one or more processors, cause the one or more processors to at least perform the following steps:
maintaining statistics about which of the one or more content identifiers is selected; and
based on the statistics, modifying the one or more content identifiers related to the predetermined sequence of characters.
